(19) United States
(12) Patent Application Publication
(10) Pub. No.: US 2025/0063467 A1
(43) Pub. Date: Feb. 20, 2025

(54) METHOD AND SYSTEM FOR CONFIGURING A WIRELESS INTERFACE OF A BUILDING CONTROLLER

(71) Applicant: Honeywell International Inc., Charlotte, NC (US)

(72) Inventors: Guy Zebrick, Millington, TN (US); Rajat Saha, Bangalore (IN); Ravi Bharathi Krishnan, Bangalore (IN); Selvakumar P, Tamil Nadu (IN); Shyamsundhar Madhusudhan, Chennai (IN); Torsha Das, Bangalore (IN); Vinoth Kumar Dellii, Tamil Nadu (IN)

(21) Appl. No.: 18/793,476

(22) Filed: Aug. 2, 2024

(30) Foreign Application Priority Data
Aug. 16, 2023 (IN) 202311054910

(51) Int. Cl. H04W 40/24; H04L 12/28; H04W 76/18

(52) U.S. Cl. CPC H04W 40/248; H04W 76/18; H04L 12/2803

(57) ABSTRACT

A building controller stores a default configuration for a wireless interface. The wireless interface is configured with the default configuration and the building controller establishes a wireless network connection with a configuration tool via a default wireless access point. The building controller receives an updated configuration from the configuration tool. After receiving the updated configuration, the building controller configures the wireless interface with the updated configuration, and terminates the wireless network connection with the default wireless access point. With the wireless interface configured with the updated wireless configuration, the building controller attempts to establish a wireless network connection via the wireless interface with a remote device using the updated wireless configuration. When the building controller successfully establishes the wireless network connection with the remote device using the updated configuration, the building controller disables the default configuration of the wireless interface of the building controller.

The present application claims priority to India Provisional Application No. 202311054910, filed on Aug. 16, 2023, entitled “A METHOD AND SYSTEM FOR CONFIGURING A WIRELESS INTERFACE OF A BUILDING CONTROLLER”, which is incorporated herein by reference.

### TECHNICAL FIELD

The present disclosure relates to methods and systems for configuring a building controller, and more particularly to methods and systems for configuring a wireless interface of a building controller.

### BACKGROUND

Building control systems such as security systems, fire safety systems, lighting systems and HVAC (Heating, Ventilating and Air Conditioning) systems can include a large number of individual building controllers that need to be connected to an appropriate wireless network in order the building control system to function as intended. Each building controller must typically be configured by a technician to bring the building controller on-line. However, errors in configuring the wireless interface of a building controller can leave the building controller unable to connect to the appropriate wireless network. For security reasons, in order to recover from a misconfigured wireless interface, the technician must often perform a factory reset of the building controller to restore the wireless interface of the building controller back to the factory settings so that the technician can again gain access the building controller and try to configure the wireless interface again. This can be a time consuming and tedious process, especially when a large number of individual building controllers are involved. What would be desirable are improved methods and systems for configuring a wireless interface of a building controller.

### SUMMARY

The present disclosure relates to methods and systems for configuring a building controller and more particularly to methods and systems for configuring a wireless interface of a building controller. An example method includes storing a default wireless configuration for the wireless interface of a building controller in a non-volatile memory of the building controller. The building controller establishes via the wireless interface a wireless network connection with a default wireless access point present in the building using the default wireless configuration. A configuration tool may gain access to the building controller via the default wireless access point by connecting to the default wireless access point using the default wireless configuration. The configuration tool may then provide an updated wireless configuration to configure the wireless interface of the building controller to communicate with a remote device, such a remote access point of a building control network. That is, the building controller may receive an updated wireless configuration from the configuration tool via the wireless network connection with the default wireless access point. After receiving the updated wireless configuration, the building controller configures the wireless interface of the building controller with the updated wireless configuration, and terminates the wireless network connection with the previous default wireless access point. With the wireless interface configured with the updated wireless configuration, the building controller attempts to establish a wireless network connection via the wireless interface with the remote device, such as an access point of the building control network. When the building controller successfully establishes the wireless network connection with the remote device using the updated wireless configuration, the building controller disables the default wireless configuration of the wireless interface to thereby prevent subsequent attempts to establish via the wireless interface a subsequent network connection with the building controller using the default wireless configuration. When the building controller does not successfully establish the wireless network connection with the remote device using the updated wireless configuration, the building controller automatically reconfigures the wireless interface back to the default wireless configuration to allow subsequent attempts to establish via the wireless interface a subsequent network connection using the default wireless configuration.

Another example may be found in a building controller. The building controller includes a housing, a wireless interface housed by the housing, a non-volatile memory housed by the housing for storing a default wireless configuration for the wireless interface, and a controller housed by the housing operatively coupled to the wireless interface and the non-volatile memory. In this example, the controller is configured to configure the wireless interface with the default wireless configuration and to establish via the wireless interface a wireless network connection with a default access point using the default wireless configuration, wherein the default wireless access point is in communication with a configuration tool. The controller is configured to receive an updated wireless configuration from the configuration tool via the wireless network connection with the default access point, and store the updated wireless configuration in the non-volatile memory. The controller is configured to configure the wireless interface with the updated wireless configuration, terminate the wireless network connection with the default access point, and attempt to establish a wireless network connection via the wireless interface with a remote device. When the wireless network connection is successfully established with the remote device using the updated wireless configuration, the controller is configured to disable the default wireless configuration of the wireless interface to thereby prevent subsequent attempts to establish via the wireless interface a subsequent network connection with the building controller using the default wireless configuration. When the wireless network connection is not successfully established with the remote device using the updated wireless configuration, the controller is configured to automatically reconfigure the wireless interface back to the default wireless configuration to allow subsequent attempts to establish via the wireless interface a subsequent network connection using the default wireless configuration.

Another example may be found in a non-transitory computer readable medium storing instructions that when executed by one or more processors of a building controller, cause the building controller to configure a wireless interface of the building controller with a default wireless configuration and to establish via the wireless interface a wireless network connection using the default wireless configuration. The building controller is caused to receive an updated wireless configuration via the wireless network connection and to configure the wireless interface with the updated wireless configuration. The building controller is caused to attempt to establish a wireless network connection via the wireless interface with a remote device using the updated wireless configuration. When the wireless network connection is successfully established with the remote device using the updated wireless configuration, the building controller is caused to disable the default wireless configuration of the wireless interface to thereby prevent subsequent attempts to establish via the wireless interface a subsequent network connection using the default wireless configuration. When the wireless network connection is not successfully established with the remote device using the updated wireless configuration, the building controller is caused to automatically reconfigure the wireless interface back to the default wireless configuration to allow subsequent attempts to establish via the wireless interface a subsequent network connection with the building controller using the default wireless configuration.

In some cases, the default wireless configuration may correspond to a previous updated wireless configuration. In some cases, the remote device may be a remote wireless access point, and the default wireless access point may be the same device as the remote wireless device but configured with different wireless configuration settings. In one example, an access point configured with the default wireless configuration may be considered the default wireless access point, while the same access point configured with the updated wireless configuration may be considered the remote wireless access point device. When so provided, the same access point may function as the default wireless access point (at some times) and the remote wireless access point (at other times). In this example, a configuration tool may establish a wireless network connection with the access point (configured as the default wireless access point) using the default wireless configuration. In some cases, the default wireless configuration may correspond to a previous updated wireless configuration, while in other cases the default wireless configuration may correspond to factory wireless configuration settings. The building controller may establish via the wireless interface a wireless network connection with the access point (configured as the default wireless access point) using the default wireless configuration. The building controller may receive an updated wireless configuration from the configuration tool via the access point (configured as the default wireless access point). After receiving the updated wireless configuration, the building controller may configure the wireless interface of the building controller with the updated wireless configuration, and may terminate the wireless network connection with the access point (configured as the default wireless access point). The access point may then be configured to use the updated wireless configuration, causing the access point to function as the remote wireless access point. With the wireless interface of the building controller configured with the updated wireless configuration, and the access point configure as the remote wireless access point, the building controller may attempt to establish a wireless network connection via the wireless interface with the access point (configured as the remote wireless access point). When the building controller successfully establishes the wireless network connection with the access point (configured as the remote wireless access point) using the updated wireless configuration, the building controller may disable the default wireless configuration of the wireless interface to thereby prevent subsequent attempts to establish via the wireless interface a subsequent network connection using the default wireless configuration. When the building controller does not successfully establish the wireless network connection with the access point (configured as the remote wireless access point) using the updated wireless configuration, the building controller may automatically configure the wireless interface of the building controller back to the default wireless configuration to allow subsequent attempts to establish via the wireless interface a subsequent network connection using the default wireless configuration.

The preceding summary is provided to facilitate an understanding of some of the innovative features unique to the present disclosure and is not intended to be a full description. A full appreciation of the disclosure can be gained by taking the entire specification, claims, figures, and abstract as a whole.

### BRIEF DESCRIPTION OF THE FIGURES

The disclosure may be more completely understood in consideration of the following description of various examples in connection with the accompanying drawings, in which:

FIG. 1 is a schematic block diagram showing an illustrative building control system;

FIG. 2 is a schematic block diagram showing an illustrative building controller that is part of the illustrative building control system of FIG. 1;

FIGS. 3A and 3B are flow diagrams that together show an illustrative method taken by an illustrative controller that is part of the illustrative building controller of FIG. 2;

FIGS. 4A and 4B are flow diagrams that together show an illustrative method for configuring a wireless interface of a building controller; and

FIG. 5 is a flow diagram showing an illustrative method for configuring a wireless interface of a building controller.

While the disclosure is amenable to various modifications and alternative forms, specifics thereof have been shown by way of example in the drawings and will be described in detail. It should be understood, however, that the intention is not to limit the disclosure to the particular examples described. On the contrary, the intention is to cover all modifications, equivalents, and alternatives falling within the spirit and scope of the disclosure.

### DESCRIPTION

The following description should be read with reference to the drawings, in which like elements in different drawings are numbered in like fashion. The drawings, which are not necessarily to scale, depict examples that are not intended to limit the scope of the disclosure. Although examples are illustrated for the various elements, those skilled in the art will recognize that many of the examples provided have suitable alternatives that may be utilized.

All numbers are herein assumed to be modified by the term “about”, unless the content clearly dictates otherwise. The recitation of numerical ranges by endpoints includes all numbers subsumed within that range (e.g., 1 to 5 includes 1, 1.5, 2, 2.75, 3, 3.80, 4, and 5).

As used in this specification and the appended claims, the singular forms “a”, “an”, and “the” include the plural referents unless the content clearly dictates otherwise. As used in this specification and the appended claims, the term “or” is generally employed in its sense including “and/or” unless the content clearly dictates otherwise.

It is noted that references in the specification to “an embodiment”, “some embodiments”, “other embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is contemplated that the feature, structure, or characteristic is described in connection with an embodiment, it is contemplated that the feature, structure, or characteristic may be applied to other embodiments whether or not explicitly described unless clearly stated to the contrary.

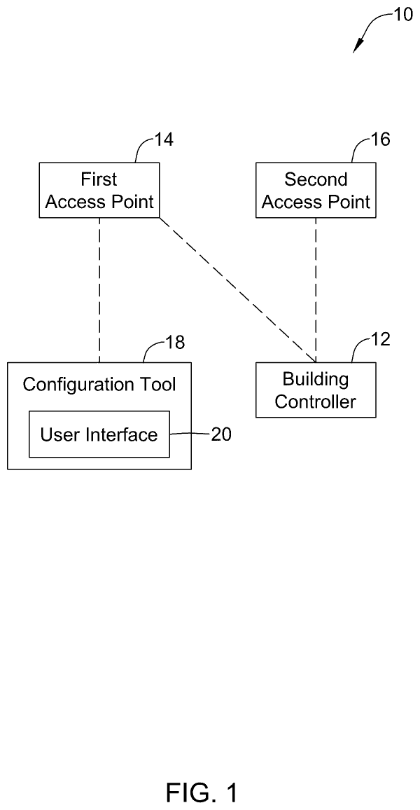

FIG. 1 is a schematic block diagram showing an illustrative building control system 10. The illustrative building control system 10 includes an illustrative building controller 12 that is configured to control operation of one or more components (not explicitly shown) of a building control system. The one or more components may include, for example, components of a security system, fire safety system, lighting system, HVAC system and/or any other building control system. FIG. 1 is directed at configuring a wireless interface of the building controller 12 to security connect with a device of the building control system 10, such as an access point 16 of the building control network of the building control system 10.

The illustrative building control system 10 includes a first access point 14 and a second access point 16. In some instances, the first access point 14 may be used by a configuration tool 18 to wirelessly access the building controller 12 and configure the wireless interface of the building controller 12 to subsequently security connect to the second access point 16. The second access point 16 may provide a wireless connection for the building controller 12 to a building control network of the building control system 10. In the example shown, the configuration tool 18 includes a user interface 20. In some instances, the configuration tool 18 may be a computer (laptop, tablet, smart phone, wearable and/or other computing device) that includes the user interface 20, for example.

In some instances, the configuration tool 18 may be configured to establish a wireless communication connection with the first access point 14. The building controller 12 may initially be configured to communicate with the first access point 14 as well. The configuration tool 18 may be used to provide the building controller 12 with the credentials necessary for the building controller 12 to establish a wireless connection with the second access point 16. In some instances, the second access point 16 may represent a wireless connection point that the building controller 12 will rely on to connect with the building control system 10.

In some instances, the building controller 12 may come out of the factory with default wireless interface configuration settings, such as default SSID and password settings, that allow the building controller 12 to form a wireless connection with the first access point 14. In some cases, the default wireless configuration may correspond to a previous updated wireless configuration. In any event, once the building controller 12 is initially deployed, the building controller 12 and the configuration tool 18 may both establish a wireless communication with the first access point 14. This may allow a user using the configuration tool 18 to access and provide the building controller 12 with updated wireless configuration settings, such as updated SSID and password settings, that will allow the building controller 12 to form a secure wireless connection with the second access point 16. Once the building controller 12 successfully forms a wireless connection with the second access point 16, the building controller 12 will automatically disables the default wireless configuration of the wireless interface of the building controller 12 to thereby prevent subsequent attempts to establish via the wireless interface a subsequent network connection with the building controller 12 using the default wireless configuration.

In some instances, the building controller 12 may fail in its initial attempt to establish communication with the second access point 16. In some instances, the building controller 12 may make several attempts to establish communication with the second access point 16. Failure to establish communication with the second access point 16 may occur because the second access point 16 may be offline, or because the building controller 12 is not properly configured to establish communication with the second access point 16. In this case, and after a predetermined number of attempts to connect with the second access point 16, the building controller 12 will attempt to re-establish communication with the first access point 14 using the default wireless interface configuration settings. For security reasons, in order to cause the building controller 12 to once again attempt to establish communication with the second access point 16, the user may need to power cycle the building controller 12, restart the configuration of the wireless interface of the building controller 12 using the configuration tool 18, and/or rewrite the updated wireless configuration settings corresponding to the second access point 16 to the building controller 12. When the building controller 12 is eventually successful in establishing communication with the second access point 16, the building controller 12 disables the default wireless configuration of the wireless interface of the building controller 12 to thereby prevent subsequent attempts to establish via the wireless interface a subsequent network connection with the building controller 12 using the default wireless configuration without, for example, first performing a factory reset on the building controller 12 or power cycling the building controller 12.

In some instances, it is possible that the building controller 12 is not able to communicate with either the first access point 14 or the second access point 16. In this situation, the building controller 12 will attempt to establish communication with the second access point 16, and may attempt to do so several times. If the building controller 12 fails to establish communication with the second access point 16, the building controller 12 will then attempt to establish or reestablish communication with the first access point 14 using the default wireless configuration of the wireless interface. In some instances, if the building controller 12 is not able to establish communication with the first access point 14, the building controller 12 will restart the process, attempting again to establish communication with the second access point 16.

In some cases, the second access point 16 may also perform the function of the first access point 14. In one example, the second access point 16 configured with the default wireless configuration may be considered the default wireless access point, while the second access point 16 configured with the updated wireless configuration may be considered the second access point 16. When so provided, the same access point (i.e. second access point 16) may function as the first access point 14 (at some times) and the second access point 16 (at other times). In this example, configuration tool 18 may establish a wireless network connection with the second access point 16 (configured as a default wireless access point) using the default wireless configuration. In some cases, the default wireless configuration may correspond to a previous updated wireless configuration, while in other cases the default wireless configuration may correspond to factory wireless configuration settings. The building controller 12 may establish via the wireless interface a wireless network connection with the second access point 16 (configured as the default wireless access point) using the default wireless configuration. The building controller 12 may receive an updated wireless configuration from the configuration tool 18 via the second access point 16 (configured as the default wireless access point). After receiving the updated wireless configuration, the building controller 12 may configure the wireless interface of the building controller 12 with the updated wireless configuration, and may terminate the wireless network connection with the second access point 16 (configured as the default wireless access point). The second access point 16 may then be configured to use the updated wireless configuration, causing the second access point 16 to function as a remote wireless access point. With the wireless interface of the building controller 12 configured with the updated wireless configuration, and the second access point 16 configure as the remote wireless access point, the building controller 12 may attempt to establish a wireless network connection via the wireless interface with the second access point 16 (configured as the remote wireless access point). When the building controller 12 successfully establishes the wireless network connection with the second access point 16 (configured as the remote wireless access point) using the updated wireless configuration, the building controller 12 may disable the default wireless configuration of the wireless interface to thereby prevent subsequent attempts to establish via the wireless interface a subsequent network connection using the default wireless configuration. When the building controller 12 does not successfully establish the wireless network connection with the second access point 16 (configured as the remote wireless access point) using the updated wireless configuration, the building controller 12 may automatically reconfigure the wireless interface of the building controller 12 back to the default wireless configuration to allow subsequent attempts to establish via the wireless interface a subsequent network connection using the default wireless configuration.

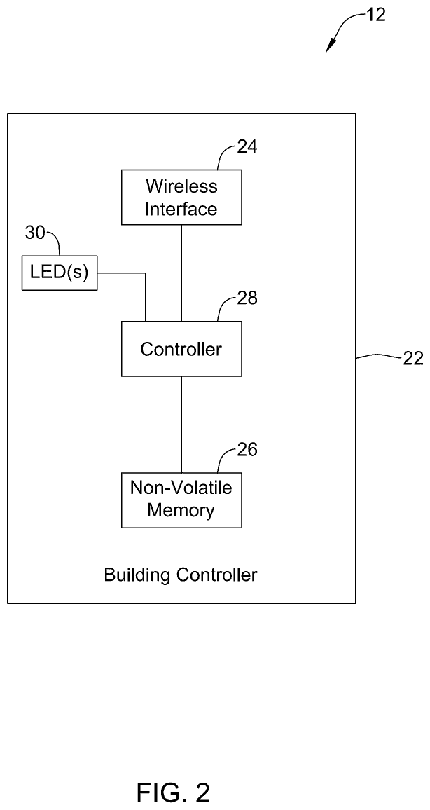

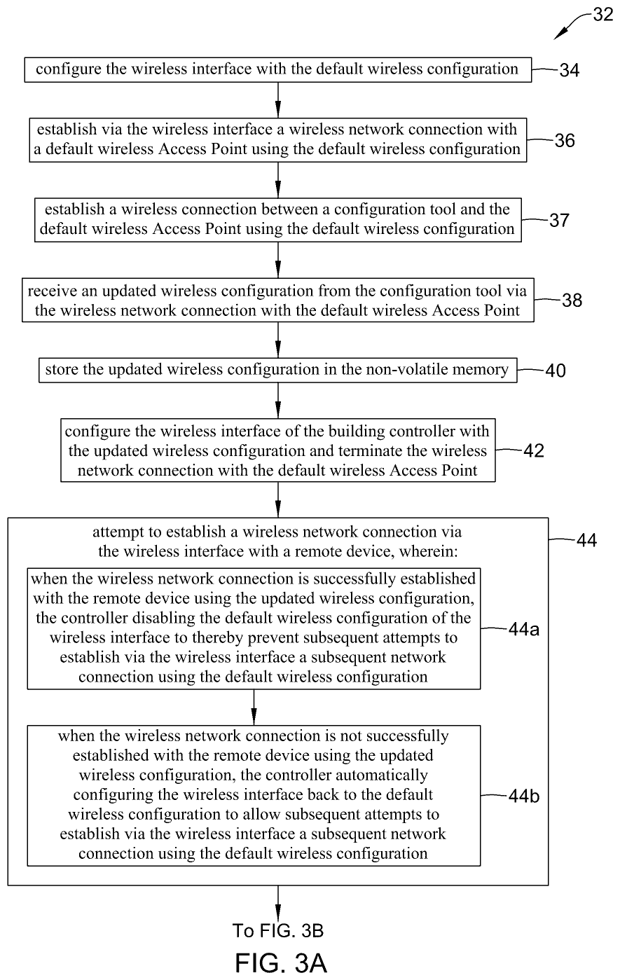

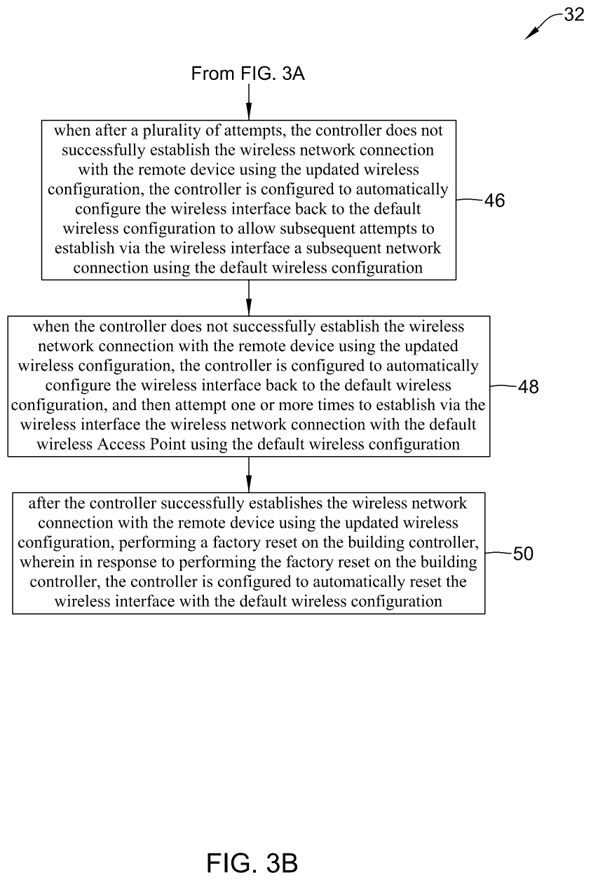

FIG. 2 is a schematic block diagram showing an illustrative building controller 12. The illustrative building controller 12 includes a housing 22. A wireless interface 24 is housed by the housing 22. In some instances, the wireless interface 24 may include a WiFi wireless interface that relies upon a default SSID and a password for connecting to WiFi wireless network. A non-volatile memory 26 is housed by the housing 22. The non-volatile memory 26 is used for storing a default wireless configuration for the wireless interface 24 of the building controller 12, and in some cases the updated wireless configuration. A controller 28 is housed by the housing 22 and is operatively coupled to the wireless interface 24 and to the non-volatile memory 26. In some instances, the building controller 12 includes one or more LEDs 30. In some instances, the controller 28 controls operation of the one or more LEDs 30 in order to indicate the status of the building controller 12. In some instances, the controller 28 may control operation of the one or more LEDs 30 in order to indicate the status of a wireless connection established by the building controller 12. The status of the wireless connection may include an indication of whether the building controller 12 is wireless communicating with the first access point 14 or the second access point 16, for example. The controller 28 is configured to carry out a number of steps, such as those outlined in FIGS. 3A and 3B.

FIGS. 3A and 3B are flow diagrams that together show an illustrative series of steps 32 that the controller 28 of FIG. 2 may be configured to carry out. The controller 28 is configured to configure the wireless interface 24 with a default wireless configuration, as indicated at block 34. The controller 28 is configured to establish via the wireless interface 24 a wireless network connection with a default wireless access point present in the building using the default wireless configuration. A configuration tool 18 may gain access to the building controller 12 via the default wireless access point 14 by connecting to the default wireless access point 14 using the default wireless configuration, as indicated at block 36. A wireless connection is established between a configuration tool and the default wireless access point using the default wireless configuration, as indicated at block 37. The controller 28 is configured to receive an updated wireless configuration from the configuration tool 18 via the wireless network connection with the default wireless access point 14, as indicated at block 38. The controller 28 is configured to store the updated wireless configuration in the non-volatile memory 26, as indicated at block 40. The controller 28 is configured to configure the wireless interface 24 of the building controller 12 with the updated wireless configuration, and terminate the wireless network connection with the default wireless access point 14, as indicated at block 42. The controller 28 is configured to attempt to establish a wireless network connection via the wireless interface 24 with a remote device (e.g. remote wireless access point 16) using the updated wireless configuration, as indicated at block 44. When the wireless network connection is successfully established with the remote device using the updated wireless configuration, the controller 28 is configured to disable the default wireless configuration of the wireless interface 24 to thereby prevent subsequent attempts to establish via the wireless interface 24 a subsequent network connection using the default wireless configuration, as indicated at block 44a. When the wireless network connection is not successfully established with the remote device using the updated wireless configuration, the controller 28 is configured to automatically reconfigure the wireless interface 24 back to the default wireless configuration to allow subsequent attempts to establish via the wireless interface 24 a subsequent network connection with the configuration tool 18 using the default wireless configuration.

Continuing on FIG. 3B, the illustrative series of steps 32 may include the controller 28 making a plurality of attempts to establish the wireless network connection with the remote device via the wireless interface 24 using the updated wireless configuration, and when after the plurality of attempts the controller 28 does not successfully establish the wireless network connection with the remote device using the updated wireless configuration, the controller 28 may be configured to automatically reconfigure the wireless interface back to the default wireless configuration to allow subsequent attempts to establish via the wireless interface 24 a subsequent network connection with the default wireless access point 14 using the default wireless configuration, as indicated at block 46. In some instances, when the controller 28 does not successfully establish the wireless network connection with the remote device using the updated wireless configuration, the controller 28 may be configured to automatically configure the wireless interface 24 back to the default wireless configuration, and then attempt one or more times to establish via the wireless interface 24 the wireless network connection with the default wireless access point 14 using the default wireless configuration, as indicated at block 48.

In some instances, after the controller 28 successfully establishes the wireless network connection with the remote device using the updated wireless configuration, in order to establish a wireless connection with the configuration tool using the default wireless configuration, a factory reset may be performed on the building controller 12. In some cases, power cycling the building controller 12, as oppose to doing a factory reset, will not reconfigure the wireless connection back to default wireless configuration, but rather the building controller will restart using the updated wireless configuration and reconnect to the remote device (e.g. the building control network).

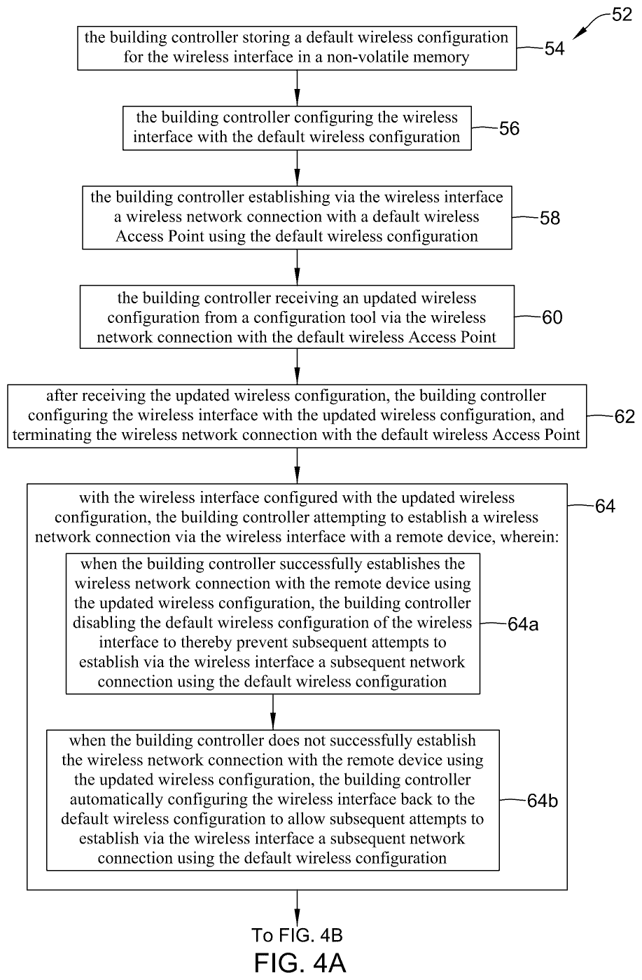

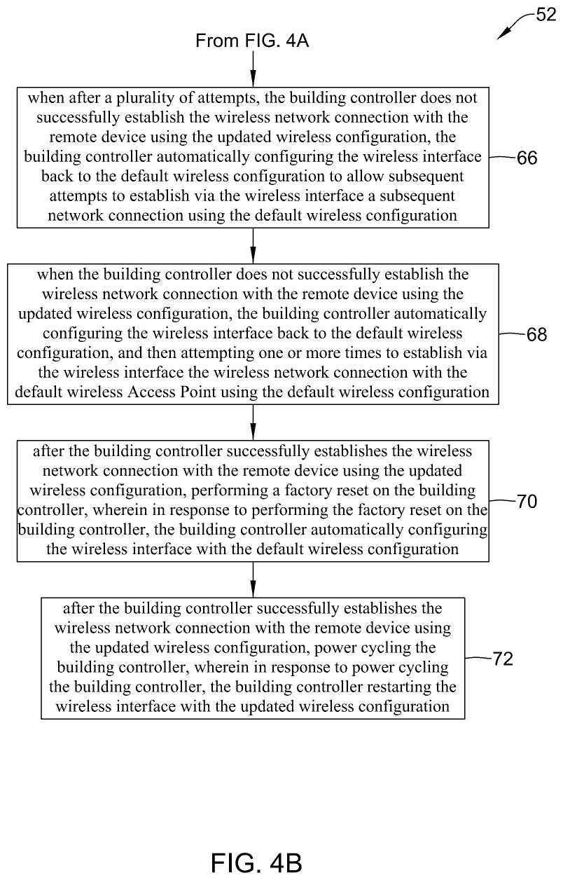

FIGS. 4A and 4B are flow diagrams that together show an illustrative method 52 for configuring a wireless interface (such as the wireless interface 24) of a building controller (such as the building controller 12). The illustrative method 52 includes the building controller storing a default wireless configuration for the wireless interface in a non-volatile memory, as indicated at block 54. The building controller configures the wireless interface with the default wireless configuration, as indicated at block 56. The building controller establishes via the wireless interface a wireless network connection with a default wireless access point present in the building using the default wireless configuration, as indicated at block 58. In some instances, a configuration tool may gain access to the building controller via the default wireless access point by connecting to the default wireless access point using the default wireless configuration. In some cases, the configuration tool includes a computing device with a user interface for receiving user input to define at least part of updated wireless configuration.

In some instances, the configuration tool is established through the default wireless access point (such as first access point 14 of FIG. 1), wherein the default wireless access point establishes a wireless network connection with the wireless interface of the building controller using the default wireless configuration, and wherein the default wireless access point establishes a network connection with the configuration tool using the default wireless configuration. In some instances, the wireless network connection with the configuration tool is established directly between the configuration tool and the building controller, with no intervening or separate access point. In some cases, the configuration tool and/or the building controller may provide the access point functionality allowing a direct link. The wireless interface may include a WiFi wireless interface, and the default wireless configuration may include a default SSID and a default password.

With the wireless network connection established with the configuration tool using the default wireless access point, the building controller receives an updated wireless configuration from the configuration tool, as indicated at block 60. The updated wireless configuration may include, for example, one or more of an updated SSID and an updated password. In some cases, security certificates may also be included (e.g. root, private and/or public keys). After receiving the updated wireless configuration, the building controller configures the wireless interface with the updated wireless configuration, and terminates the wireless network connection with the default wireless access point, as indicated at block 62.

With the wireless interface configured with the updated wireless configuration, the building controller attempts to establish a wireless network connection via the wireless interface with a remote device (e.g. an access point of a building control network), as indicated at block 64. When the building controller successfully establishes a wireless network connection with the remote device using the updated wireless configuration, the building controller automatically disables the default wireless configuration of the wireless interface to thereby prevent subsequent attempts to establish via the wireless interface a subsequent network connection using the default wireless configuration, as indicated at block 64a. This improves security. When the building controller does not successfully establish the wireless network connection with the remote device using the updated wireless configuration, sometimes after one or more retry attempts, the building controller automatically reconfigures the wireless interface back to the default wireless configuration to allow subsequent attempts to establish via the wireless interface a subsequent network connection via the configuration tool using the default wireless configuration, as indicated at block 66b.

Continuing on FIG. 4B, the method 52 may include the building controller making a plurality of attempts to establish the wireless network connection with the remote device using the updated wireless configuration, and when after the plurality of attempts the building controller does not successfully establish the wireless network connection with the remote device, the building controller may automatically reconfigure the wireless interface back to the default wireless configuration to allow subsequent attempts to establish via the wireless interface a subsequent network connection with the configuration tool using the default wireless configuration, as indicated at block 66. When the building controller does not successfully establish the wireless network connection with the remote device using the updated wireless configuration, the building controller may automatically reconfigure the wireless interface back to the default wireless configuration, and then attempt one or more times to establish via the wireless interface the wireless network connection with the default wireless access point using the default wireless configuration, as indicated at block 68.

In some instances, the method 52 may further include, after the building controller successfully establishes the wireless network connection with the remote device using the updated wireless configuration, performing a factory reset on the building controller, wherein in response to performing the factory reset on the building controller, the building controller automatically configures the wireless interface with the default wireless configuration, as indicated at block 70. In some instances, after the building controller successfully establishes the wireless network connection with the remote device using the updated wireless configuration, the method 52 may include power cycling the building controller, wherein in response to power cycling the building controller, the building controller restarting the wireless interface with the updated wireless configuration, as indicated at block 72. In some instances, the building controller may include one or more LEDs, and the building controller may indicate via the one or more LEDs whether the building controller successfully established the wireless network connection with the remote device or not, and/or whether the building controller successfully established the wireless network connection with the configuration tool or not.

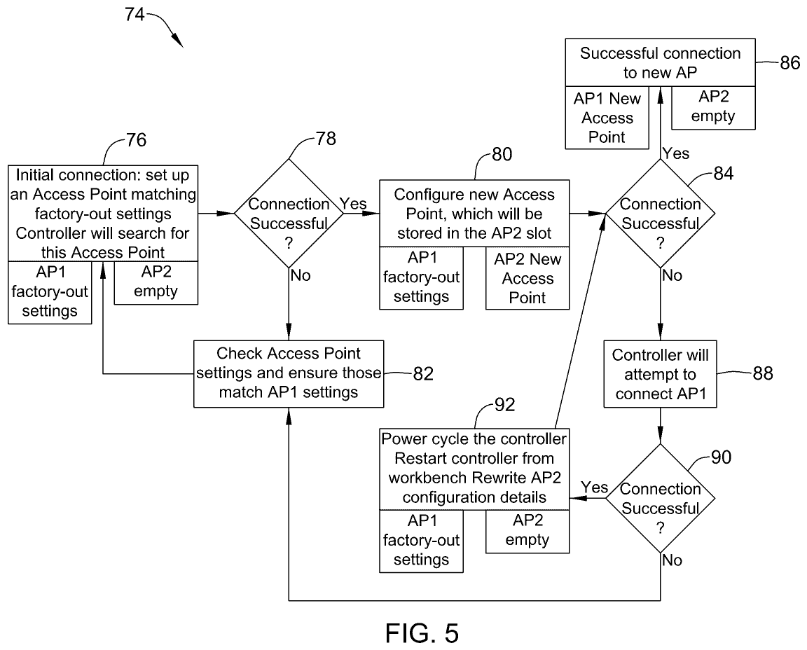

FIG. 5 is a flow diagram showing an illustrative method 74 for establishing wireless communication between a building controller (such as the building controller 12) and an access point (such as the first access point 14 or the second access point 16). In this example, the building controller is configured to search for an access point matching the factory-out settings (e.g. default wireless configuration), as indicated at block 76. The building controller stored the factory-out settings in a non-volatile memory for establishing communication with a first access point using the factory-out settings. The building controller does not yet have updated settings for establishing secure communication with a second access point, such as an access point of a building control network. At a decision block 78, a determination is made as to whether the building controller successfully established a connection with the first access point. If yes, control passes to block 80, where the building controller is programmed with updated wireless configuration for establishing secure communication with the second access point, typically received from a configuration tool via the connection with the first access point. At this point, an LED associated with the building controller (e.g. visible from outside the housing of the building controller) may glow a solid green, for example. If no, control passes to block 82 and the access credentials of the first access point are double checked to make sure they match the factory-out settings of the building controller. Once checked and fixed, control then reverts back to block 76.

From block 80, control passes to a decision block 84, where a determination is made as to whether the building controller successfully connected to the second access point. If so, control passes to block 86, indicating a successful connection to the second access point (e.g. an access point of a building control network). The LED associated with the building controller may glow a solid green, for example. As shown, the credentials are establishing communication with the second access point are the only credentials retained by the building controller, and the factory-out settings are disabled to thereby prevent subsequent attempts to establish via the wireless interface a subsequent network connection with the building controller using the default wireless configuration.

If the building controller did not successfully connect to the second access point, control passes to block 88, where the building controller will attempt to connect with the first access point. The LED associated with the building controller may flash green, with any of a variety of different flashing patterns such as an “on”, “on”, “off” pattern. Control then passes to a decision block 90, where a determination is made as to whether the building controller successfully connected with the first access point. If so, the LED associated with the building controller may flash yellow, and control may pass to block 92 where either the building controller is power cycled, the building controller is restarted, a factory reset is performed on the building controller or the updated wireless configuration details for the second access point are checked and rewritten. From there, control reverts to decision block 84. If at decision block 90 the answer is no, the LED associated with the building controller may flash green, and control may revert to block 82. The particular colors referenced herein for the LED are merely illustrative, as any color and/or color sequence may be used. As an example, a red LED may indicate a lack of WiFi connection.

Having thus described several illustrative embodiments of the present disclosure, those of skill in the art will readily appreciate that yet other embodiments may be made and used within the scope of the claims hereto attached. It will be understood, however, that this disclosure is, in many respects, only illustrative. Changes may be made in details, particularly in matters of shape, size, arrangement of parts, and exclusion and order of steps, without exceeding the scope of the disclosure. The disclosure's scope is, of course, defined in the language in which the appended claims are expressed.

What is claimed is:

1. A method for configuring a wireless interface of a building controller, the method comprising:
the building controller storing a default wireless configuration for the wireless interface in a non-volatile memory;
the building controller configuring the wireless interface with the default wireless configuration;
the building controller establishing via the wireless interface a wireless network connection with a default wireless access point using the default wireless configuration;
a configuration tool establishing a wireless network connection with the default wireless access point using the default wireless configuration;
the building controller receiving an updated wireless configuration from the configuration tool via the default wireless access point;
after receiving the updated wireless configuration, the building controller configuring the wireless interface of the building controller with the updated wireless configuration, and terminating the wireless network connection with the previous default wireless access point;
with the wireless interface configured with the updated wireless configuration, the building controller attempting to establish a wireless network connection via the wireless interface with a remote device, wherein:
when the building controller successfully establishes the wireless network connection with the remote device using the updated wireless configuration, the building controller disabling the default wireless configuration of the wireless interface to thereby prevent subsequent attempts to establish via the wireless interface a subsequent network connection using the default wireless configuration; and
when the building controller does not successfully establish the wireless network connection with the remote device using the updated wireless configuration, the building controller automatically configuring the wireless interface back to the default wireless configuration to allow subsequent attempts to establish via the wireless interface a subsequent network connection using the default wireless configuration.

2. The method of claim 1, wherein the configuration tool comprises a computing device with a user interface for receiving user input to define at least part of the updated wireless configuration.

3. The method of claim 2, wherein the default wireless access point comprises a wireless router.

4. The method of claim 1, wherein the remote device is an access point of a building control network.

5. The method of claim 1, wherein the wireless interface of the building controller comprises a WiFi wireless interface, and the default wireless configuration comprises a default SSID and a default password.

6. The method of claim 5, wherein the updated wireless configuration comprises one or more of an updated SSID and an updated password.

7. The method of claim 1, wherein the building controller making a plurality of attempts to establish the wireless network connection via the wireless interface with the remote device, and when after the plurality of attempts, the building controller does not successfully establish the wireless network connection with the remote device using the updated wireless configuration, the building controller automatically configuring the wireless interface of the building controller back to the default wireless configuration to allow subsequent attempts to establish via the wireless interface a subsequent network connection using the default wireless configuration.

8. The method of claim 1, wherein when the building controller does not successfully establish the wireless network connection with the remote device using the updated wireless configuration, the building controller automatically configuring the wireless interface back to the default wireless configuration, and then attempting one or more times to establish via the wireless interface the wireless network connection with the default wireless access point using the default wireless configuration.

9. The method of claim 1, wherein after the building controller successfully establishes the wireless network connection with the remote device using the updated wireless configuration, performing a factory reset on the building controller, wherein in response to performing the factory reset on the building controller, the building controller automatically configuring the wireless interface with the default wireless configuration.

10. The method of claim 1, wherein after the building controller successfully establishes the wireless network connection with the remote device using the updated wireless configuration, power cycling the building controller, wherein in response to power cycling the building controller, the building controller restarting the wireless interface with the updated wireless configuration.

11. The method of claim 1, wherein the building controller includes one or more LEDs, and wherein the building controller indicating via the one or more LEDs whether the building controller successfully established the wireless network connection with the remote device or not.

12. A building controller, comprising:
a housing;
a wireless interface housed by the housing;
a non-volatile memory housed by the housing for storing a default wireless configuration for the wireless interface;
a controller housed by the housing operatively coupled to the wireless interface and the non-volatile memory, the controller configured to:
configure the wireless interface with the default wireless configuration;
establish via the wireless interface a wireless network connection with a default wireless access point using the default wireless configuration, wherein the default wireless access point is in communication with a configuration tool;
receive an updated wireless configuration from the configuration tool via the wireless network connection with the default wireless access point;
store the updated wireless configuration in the non-volatile memory;
configure the wireless interface with the updated wireless configuration, and terminating the wireless network connection with the default wireless access point;
attempt to establish a wireless network connection via the wireless interface with a remote device, wherein:
when the wireless network connection is successfully established with the remote device using the updated wireless configuration, the controller disabling the default wireless configuration of the wireless interface to thereby prevent subsequent attempts to establish via the wireless interface a subsequent network connection using the default wireless configuration; and
when the wireless network connection is not successfully established with the remote device using the updated wireless configuration, the controller automatically configuring the wireless interface back to the default wireless configuration to allow subsequent attempts to establish via the wireless interface a subsequent network connection using the default wireless configuration.

13. The building controller of claim 12, wherein the wireless interface comprises a WiFi wireless interface, and the default wireless configuration comprises a default SSID and a default password.

14. The building controller of claim 13, wherein the updated wireless configuration comprises one or more of an updated SSID and an updated password.

15. The building controller of claim 12, wherein the controller is configured to make a plurality of attempts to establish the wireless network connection with the remote device using the updated wireless configuration, and when after the plurality of attempts, the controller does not successfully establish the wireless network connection with the remote device using the updated wireless configuration, the controller is configured to automatically reconfigure the wireless interface back to the default wireless configuration to allow subsequent attempts to establish via the wireless interface a subsequent network connection using the default wireless configuration.

16. The building controller of claim 12, wherein when the controller does not successfully establish the wireless network connection with the remote device using the updated wireless configuration, the controller is configured to automatically reconfigure the wireless interface back to the default wireless configuration, and then attempt one or more times to establish via the wireless interface the wireless network connection with the default wireless access point using the default wireless configuration.

17. The building controller of claim 12, wherein after the controller successfully establishes the wireless network connection with the remote device using the updated wireless configuration, restarting the building controller, wherein in response to restarting the building controller, the controller is configured to automatically reset the wireless interface with the default wireless configuration.

18. The building controller of claim 12, wherein the building controller includes one or more LEDs visible from outside of the housing, and wherein the controller is configured to indicate via the one or more LEDs whether the building controller successfully established the wireless network connection with the remote device or not.

19. A non-transitory computer readable medium storing instructions that when executed by one or more processors of a building controller, cause the building controller to:
configure a wireless interface of the building controller with a default wireless configuration;
establish via the wireless interface a wireless network connection using the default wireless configuration;
receive an updated wireless configuration via the wireless network connection;
configure the wireless interface with the updated wireless configuration;
attempt to establish a wireless network connection via the wireless interface with a remote device, wherein;
when the wireless network connection is successfully established with the remote device using the updated wireless configuration, disabling the default wireless configuration of the wireless interface to thereby prevent subsequent attempts to establish via the wireless interface a subsequent network connection using the default wireless configuration; and
when the wireless network connection is not successfully established with the remote device using the updated wireless configuration, automatically configure the wireless interface back to the default wireless configuration to allow subsequent attempts to establish via the wireless interface a subsequent network connection using the default wireless configuration.

20. The non-transitory computer readable medium of claim 19, wherein the wireless interface comprises a WiFi wireless interface, and the default wireless configuration comprises a default SSID and a default password, and the updated wireless configuration comprises one or more of an updated SSID and an updated password.
